(19) United States
(12) Patent Application Publication
(10) Pub. No.: US 2025/0377637 A1
(43) Pub. Date: Dec. 11, 2025

(54) SAFETY SYSTEM AND METHOD OF SAFEGUARDING A MACHINE

(71) Applicant: SICK AG, Waldkirch (DE)

(72) Inventor: Markus HAMMES, Waldkirch (DE)

(21) Appl. No.: 19/197,001

(22) Filed: May 2, 2025

(30) Foreign Application Priority Data
Jun. 5, 2024 (EP) 24180077.0

(51) Int. Cl. G05B 9/02

(52) U.S. Cl. CPC G05B 9/02

(57) ABSTRACT

A safety system for safeguarding a machine is provided that has at least one safe sensor and one unsafe evaluation unit, wherein the safe sensor has a protected field evaluation, a safe interface, and an unsafe interface to output sensor data to the unsafe evaluation unit; and wherein the unsafe evaluation unit determines object positions of objects located in the detection by an unsafe position evaluation. In this respect, the object positions are plausibilized based on the monitoring of the at least one protected field.

The invention relates to a safety system and to a method of safeguarding a machine respectively.

Optoelectronic sensors are very frequently used in contactless monitoring for safeguarding hazards, for instance machines in an industrial environment or vehicles in logistics applications. A laser scanner and a camera, and in particular a 3D camera, can primarily be named here particularly for more complex applications. A 3D camera measures a distance and thereby acquires depth information. The detected three-dimensional image data having spacing values or distance values for the individual pixels are also called a 3D image, a distance image, or a depth map. There are 3D cameras in different technologies, including time of flight processes, stereoscopic processes, and projection processes or plenoptic cameras. A scene is illuminated by amplitude-modulated light in a time of flight (TOF) camera still to be looked at in somewhat more detail. The light returning from the scene is received and is demodulated using the same frequency that is also used for the modulation of the transmitted light (lock-in process). A measured amplitude value results from the demodulation that corresponds to a scan value of the received signal.

Conventionally, a protected field is frequently monitored which may not be entered by operators during the operation of the machine. If the sensor recognizes an unauthorized protected field intrusion, for instance a leg of an operator, the machine is switched into a safe state. The simultaneous monitoring of a plurality of protected fields and a switching over of protected fields is furthermore known. Sensors used in safety engineering have to work particularly reliably and must therefore satisfy high safety demands, for example the EN13849 standard for safety of machinery and the machinery standard EN61496 for electrosensitive protective equipment (ESPE). To satisfy these safety standards, a series of measures have to be taken such as a secure electronic evaluation by redundant, diverse electronics or different functional monitoring processes, especially the monitoring of the contamination of optical components, including a front screen.

A safety laser scanner or a safety camera that satisfies these standards and is configured for a protected field evaluation works internally with very large amounts of information of the scan point clouds or depth maps. However, only highly dense binary information is safely provided externally, namely whether the protected field has been infringed or not. For this purpose, a safe output (OSSD, output signal switching device) is typically used. More complex safe evaluations such as a position determination of an object or object tracking are conventionally not available. There have admittedly long been algorithms for object tracking with an optical detection that are based on classical image processing, Kalman filters, or also increasingly artificial intelligence. The reliable knowledge of the exact position of persons and other objects would also be considerably more valuable for risk reduction functions than only the knowledge of the presence of an object in a protected field. However, there are no suitable products available certified for applications in safety engineering. A little more precisely, in particular today's safe 3D camera systems absolutely deliver 3D data comprising all the information required for an object localization. Sufficiently performant controllers or other processing units, however, do not correspond to the safety demands while conversely a safety controller does not provide sufficient processing power.

EP 3 470 879 A1 configures at least partially mutually overlapping monitoring fields in a laser scanner. Monitoring segments are thereby produced that differ from one another by which monitored fields overlap there. The number of monitored fields provided at the hardware side is thus refined to the monitored segments.

EP 3 709 106 A1 proposes a safety system that validates complex, unsafe evaluations by less complex safe evaluations.

In DE 10 2017 105 174 B4 training data are generated for an artificial neural network. Image data are evaluated as safety critical or unsafety critical depending on whether a safe sensor triggers a safety related safeguarding or not at the time of the recording of the image data. However, the safe sensor does not have any special properties with respect to its evaluation that go beyond a protected field function.

EP 4 325 308 A1 describes a safety system in which result signals of a respective control and evaluation unit of a safety system and of a programmable controller are compared with one another. This is a cross-comparison of two equivalent functions; a more complex safe function such as object tracking is not made possible in this manner.

The still unpublished European patent application having the file reference 23162021.2 deals with a monitoring device for safe object tracking. In this respect, protected fields are configured with partial protected fields that enable a discrete variant of safe object tracking. The resolution is thereby limited and it is not possible to simultaneously track a plurality of objects.

It is therefore the object of the invention to make more complex safety functions possible.

This object is satisfied by a safety system and by a method for safeguarding a machine in accordance with the respective independent claim. A first safe sensor detects sensor data from an environment of the machine and monitors at least one protected field on the basis of the sensor data. A safety output signal to a safe interface of the first sensor (OSSD, output signal switching device) results from this and the status of the output signal provides information on whether the protected field has been infringed or not, that is whether an unpermitted object is located therein or not. A protected field infringement does not necessarily or directly lead to a safety response of the machine, the safe output signal can be differently processed. The first sensor additionally has an unsafe interface to output sensor data, for example two-dimensional or three-dimensional image data or point clouds, optionally after pre-processing.

An unsafe evaluation unit such as a standard controller, an edge device, or an industrial PC receives the sensor data from the unsafe interface and determines object positions in an unsafe position evaluation or object localization. In this respect, complex evaluations are possible that require a high performance of the unsafe evaluation unit and that cannot be performed in an available certified safety controller.

Safe and safety mean, as in the total description, that measures are take to control errors up to a specific safety level or to observe regulations of a relevant safety standard for machine safety or for electrosensitive protective equipment, of which some have been named in the introduction. Unsafe is the opposite of safe and accordingly said demands on failsafeness are not satisfied or are at least not required for unsafe devices, transmission paths, evaluations, and the like and accordingly, viewed in isolation for a respective unsafe unit or evaluation, diagnostic and safeguarding mechanisms for the satisfaction of a specified safety level are not ensured.

The invention starts from the basic idea of plausibilizing or checking the originally unsafe object position on the basis of the protected field monitoring. The object position can thereby be used in a safety context; a safe object position in particular results.

The invention has the advantage that a used protected field function already certified as safe can in one sense be co-opted to check the position evaluation. The object position can thus be made usable for safety engineering applications using existing safe components in a simple and inexpensive architecture by a system approach using comparison or diagnostic mechanisms during operation in accordance with the specifications of the relevant safety standards. This check can be implemented using different architectures and check logics.

A plurality of protected fields are preferably stored in the first safe evaluation unit that together form a pattern for possible object positions in the detection zone. This means that a safe object position becomes detectable in the resolution of the pattern due to the identity of an infringed protected field. The pattern can be applied in any desired coordinates, for example circular rings for polar coordinates, and/or can be irregular, for instance denser on an increasing proximity to the machine. Making the pattern finer can be achieved by a kind of fingerprint of overlapping protected fields, as described in EP 3 470 879 A1 named in the introduction. The protected fields are stored in a separate memory of the safe evaluation unit or in a memory of the sensor to which it has access. In this respect, protected fields can be preconfigured and/or dynamically generated or adapted.

Depending on the object position in the pattern, a protected field preferably excludes this object position. This is a particular manner to form the pattern. Figuratively speaking, the protected field has a hole exactly at the object position, and indeed of the size of a person or of the body part to be recognized in accordance with the detection capability plus a possible tolerance or margin, in particular calculated according to the relevant safety standards. An object position is encoded using such protected fields in that the protected field excluding this object position is actually not infringed. This can also be distinguished from the case that there is actually no object in the detection zone as part of the object tracking. Alternatively, a further protected field can be simultaneously active for this distinction that also includes the excluded zone, for example covers the entire detection zone.

The unsafe evaluation unit is preferably configured to continuously select a protected field, on the basis of a respective object position, that is not infringed by an object at this object position. The protected fields thus so-to-say move back from the object. The adaptation preferably actually takes place by switching to a protected field of a different geometry, in particular having an omission at the object position, as in the previous paragraph. An error in the unsafe position evaluation is then safely uncovered in that the protected field is actually infringed because the object is not at the expected object position.

The unsafe evaluation unit is preferably configured to continuously select a protected field, based on a respective object position, that is infringed by an object at this object position. The logic is thus so-to-say inverted, the protected fields do not move back from the object but rather move together with the object to the expected position. The expectation for a correct position evaluation is now that the protected field is constantly infringed,

The unsafe evaluation unit is preferably configured to continuously select a muting zone with reference to a respective object position. This is a third alternative to evading and co-moving protected fields. A muting zone is in principle also an omission in a protected field with the difference that it is implemented differently, namely not by the geometry of the protected field, but actually by muting a protected field in the region of the omission, with the muting zone now co-moving with the expected object position.

The safety system preferably has a safety controller that compares the object position with a result of the monitoring of the at least one protected field. In contrast, no safety controller is required for the previous variants. In this embodiment, the safety controller with its diagnostic function supplements the performant unsafe evaluation unit with its position evaluation. Safety controller means a safe evaluation unit that is implemented on any desired hardware, in particular a safety controller as a controller permitted for safety applications in a narrower sense.

The unsafe evaluation unit is preferably configured to predict which protected field has been infringed on the basis of the object position and to transmit this prediction to the safety controller. The prediction of infringed protected fields can then be compared with the actually infringed protected fields in the safety controller there, with an agreement only resulting when the position evaluation has determined the correct object position.

The safety system preferably has a second safe sensor for detecting sensor data from an environment of the machine that has a second safe evaluation unit for monitoring at least one protected field by a safe protected field evaluation of its sensor data; has a second safe interface to output a result of the monitoring of the at least one protected field; and has a second unsafe interface to output sensor data to the unsafe evaluation unit. A higher safety level can be reached by the use of two or even more sensors by means of redundancy or in the case of sensors not of the same design even diverse redundancy.

The safety system is preferably configured to plausibilize the object positions from sensor data of the first sensor on the basis of the monitoring of the at least one protected field of the second sensor and/or to plausibilize the object positions from sensor data of the second sensor on the basis of the monitoring of the at least one protected field of the first sensor. The plausibilization between the two sensors with their protected field monitoring and the position evaluations from the respective sensor data thus takes place crosswise. Plausibilizations in accordance with all of the embodiments only described for one sensor are also possible, that is in particular by a moving back of protected fields or a co-moving of protected fields or muting zones on the basis of the object position. A comparison of predicted and actual protected field infringements is in particular conceivable in a safety controller, again crosswise.

The unsafe evaluation unit is particularly preferably configured to carry out object tracking of objects in the detection zone. Not only the respective current objects are therefore recognized, but they are also tracked over time. This is substantially more reliable and makes more finely tuned safety concepts possible. For example, objects cannot appear in or disappear from the middle of the detection zone and a much more differentiated safety response of the machine can be derived from an object movement than from a simple instantaneous object position. The instantaneous object position is, however, at best also covered, object tracking is therefore also a form of position evaluation. Algorithms are known per se, for example, based on Kalman filters or machine learning, in particular neural networks. The special aspect is that thanks to the invention, safe object tracking can be achieved due to the plausibilization despite the initially unsafe object tracking.

The first safe sensor is preferably a 3D camera, in particular a time of flight camera. High quality sensor data are thus generated that enable complex evaluations in the unsafe evaluation unit. If there are further sensors, this applies equally to these sensors, with a combination of sensors of the same design, sensors in accordance with the same sensor principle, or directly different sensors being conceivable.

The safety system is preferably configured to store or output sensor data with an associated object position and/or a result of the protected field evaluation as annotated training data, in particular respectively triggered by a successful plausibilization, a protected field infringement, and/or a terminated protected field infringement. Important information on the objects currently located in the detection zone are automatically associated with respective sensor data by the position evaluation or protected field monitoring. This is used in this embodiment to automatically annotate the sensor data.

High-quality training data are thereby acquired and the otherwise required laborious manual annotation or labeling is omitted. Examples for labels are object positions, object lists, prior and/or future object routes, infringed and non-infringed protected fields, and a binary overall evaluation whether the current situation requires a safety response due to an impending accident or not. Training data can be generated periodically or in any other time pattern, on request, or triggered by certain situations. One interesting trigger is a successful plausibilization that ensures that the labels are correct and/or when a protected field has been infringed or is no longer infringed because then something interesting has taken place in the environment of the machine with an increased probability to which the process to be trained should react in a particularly selective manner.

The safety system preferably triggers a safety response of the machine when an object is at a hazardous position and/or in a hazardous motion. Although it is not precluded that protected field infringements enter into this hazard evaluation, the actual advantage of the invention is that the protected field monitoring only indirectly contributes because it provides safe object positions. The hazard evaluation itself then preferably takes place based on the results of the position evaluation. A hazardous position can be too close to a machine or to a machine part with possible time dependencies or the taking into account of work routines of the machine. Movements enable additional assessments since a movement in parallel with the machine, for example, or even with a partial component away therefrom is less non-critical than directly toward the machine. The speed can also play a role (speed and separation monitoring). The safeguarding can comprise an evasion, deceleration, or stopping of the machine or the adopting of another safe state.

The safety system is preferably configured as a safe people counter. Objects are safely detected and distinguished based on their object positions. Counting such as how many objects are in the detection zone can thus in particular take place very simply. If a protected field infringement is only triggered by objects of the size of persons, it already results from this that persons have been distinguished from objects. In addition, any complicated person model can be checked in the unsafe evaluation unit.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

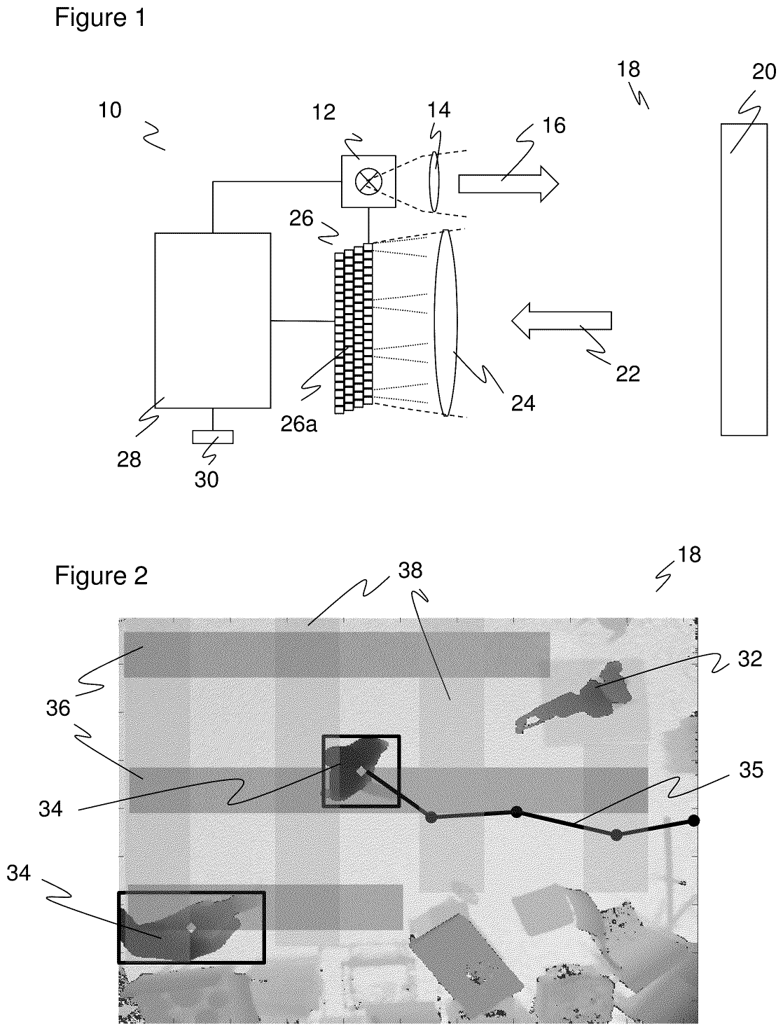

FIG. 1 a schematic representation of a 3D camera;

FIG. 2 an exemplary recording of a scan with persons, with a monitored machine, and with configured protected fields;

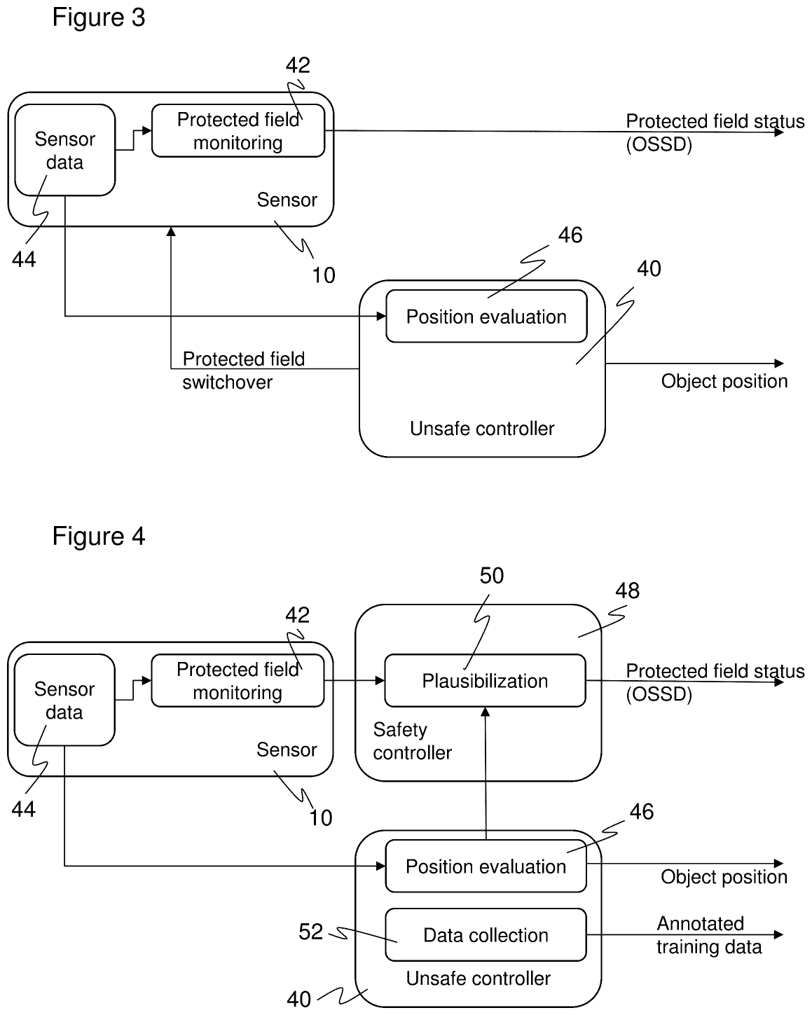

FIG. 3 a representation of a safety architecture with a safe sensor and an unsafe controller;

FIG. 4 a representation of a safety architecture with a safe sensor, an unsafe controller, and a safety controller;

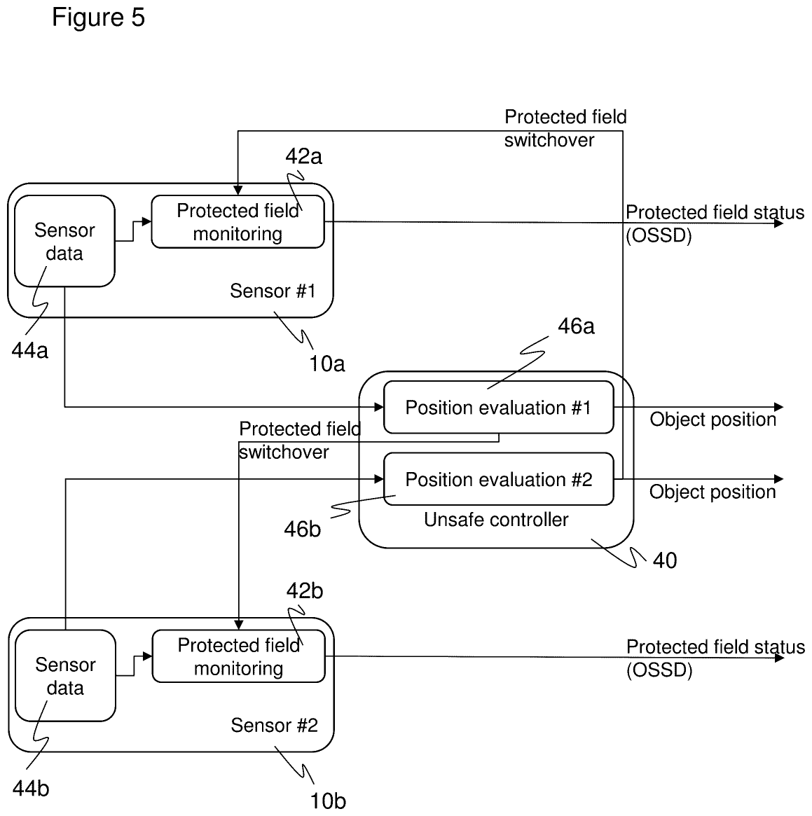

FIG. 5 a representation of a safety architecture with two safe sensors and an unsafe controller; and

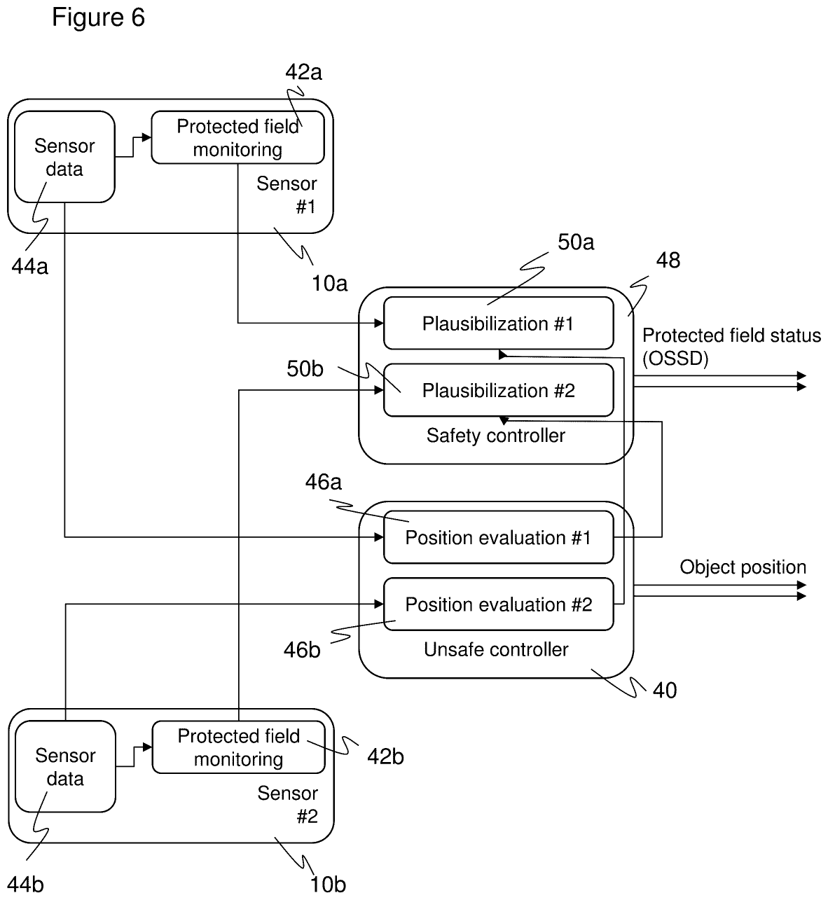

FIG. 6 a representation of a safety architecture with two safe sensors, an unsafe controller, and a safety controller.

FIG. 1 shows a schematic block diagram of a camera 10 that is preferably configured as a 3D time of flight camera and that will be described as representative for an optoelectronic sensor that can be used in connection with the invention. An illumination unit 12 transmits transmitted light 16 modulated by a transmission optics into a detection zone 18. LEDs or lasers in the form of edge emitters or VSCELs can be considered as the light source. The illumination unit 12 is controllable such that the amplitude of the transmitted limit 16 is modulated at a frequency typically in the range of 1 MHz to 1000 MHz The modulation is, for example, sinusoidal or rectangular, at least a periodic modulation. A limited unambiguity range of the distance measurement is produced by the frequency so that small modulation frequencies are required for large ranges of the camera 10. Alternatively, measurements are carried out at two to three or more modulation frequencies to increase the unambiguity range in a combination of measurements.

When the transmitted light 18 is incident on an object 20 in the detection zone 18, a portion is reflected back to the camera 10 as received light 22 and is guided there through a reception optics 24, for example a single lens or a reception objective, onto an image sensor 26. The image sensor 26 has a plurality of reception elements or reception pixels 26a arranged to form a matrix or a row, for example. The resolution of the image sensor 26 can extend from two or some few up to thousands or millions of reception pixels 26a. A demodulation corresponding to a lock-in process takes place therein. A plurality of scan values from which ultimately the phase displacement between the transmitted light 16 and the received light 22, and thus the time of flight, can be measured are generated by repeated detection with a modulation of the transmitted light 16 respectively slightly displaced over the repetitions. The pixel arrangement is typically a matrix so that a lateral spatial resolution results in an X direction and in a Y direction, which is supplemented by the Z direction of the distance measurement to form the three-dimensional image data. This 3D detection is preferably meant when a 3D camera, a 3D time of flight camera, or three-dimensional image data are spoken of. In principle, however, different pixel arrangements are also conceivable; for instance, a pixel row that is selected in a matrix or that forms the whole image sensor of a line scan camera.

The image data for a protected field monitoring are used in a control and evaluation unit 28 having at least one digital computing module such as a microprocessor or the like. The control and evaluation unit 28 has at least one evaluation circuit and preferably, at least one digital processing module such, as a microprocessor or a CPU (central processing unit), an FPGA (field programmable gate array), a DSP (digital signal processor), an ASIC (application specific integrated circuit), an AI processor, an NPU (neural processing unit), a GPU (graphics processing unit), a VPU (video processing unit), or the like. A protected field can be defined by geometrical specifications for a partial zone of the detection zone 18 that are configured or are fed in via an interface, not shown, for example in a CAD program or in any other manner by means of the control and evaluation unit 28. The protected fields are monitored for object intrusions and, on a protected field infringement, a safe output signal is output at a safe output 30 associated with the protected field. The status of the safe output accordingly binarily reflects the presence or absence of an object in the associated protected field.

FIG. 2 shows an exemplary recording of the camera 10 with some evaluation results. The depth values are only indicated by gray scale values. As will be explained below in more detail, both a protected field monitoring and a position evaluation or object localization, preferably object tracking, take place. Two persons 34 have been recognized and framed (bounding box) in the environment of a monitored machine 32, with the past trajectory 35 of a person 34 recognized by the object tracking being highlighted. Monitored protected fields 36, 38 are furthermore drawn that overlap one another to form a pattern in which there are partial zones or pattern elements that are covered by the protected fields 36, 38 and other ones that have been omitted by the protected fields 36, 38. In another respect, the individual strips shown can be both separate and mutually spaced apart partial protected fields of a common protected field. The protected field geometries are to be understood as purely by way of example; in particular a finer, irregular, or non-orthogonal pattern can be formed. It is furthermore possible that a switch is made between protected fields or that they are dynamically adapted.

FIG. 3 shows a representation of a safety architecture with a safe sensor 10 and an unsafe controller 40 to explain a test concept in an embodiment of the invention. The camera 10 in accordance with FIG. 1 is preferably used as the safe sensor 10 and the same reference numeral will therefore be used in the following. Alternatively, a different 3D sensor can be used, some types of 3D cameras are named in the introduction; a further possibility is a multilayer laser scanner or a laser scanner having a variable scan plane. Two-dimensional cameras or laser scanners are further conceivable or very different sensor principles such as radar.

The safe sensor 10 as a whole is a safe sensor in the sense defined in the introduction; that is, it satisfies a well-defined safety level, in particular from a safety standard for cameras, machine safety, electrosensitive protective equipment. The protected field monitoring 42 already addressed multiple times and the generated sensor data 44 are provided as function blocks in the safe sensor 10. The protected field monitoring 42 is a safe evaluation; externa access to the sensor data 44, even with forwarding to the unsafe controller 40, is not safe in contrast. The safe sensor 10 is accordingly, in other words, a certified safety sensor having a protected field function and an unsafe interface for the output of the sensor data.

The unsafe controller 40 is, for example, an industrial PC, an edge device, or a computer box such as Nvidia Jetson. It is important that sufficient processing and storage capacities as well as data bandwidths are provided here to allow more complex evaluations of the sensor data 44 in a position evaluation 46 of the unsafe controller, with the position evaluation 46 preferably performing object tracking. The position evaluation 46, for example, delivers so-called object lists that can contain information such as all the detected objects, their positions, IDs, bounding boxes, and similar data.

The basic idea of the invention is to plausibilize the position evaluation 46 based on the protected field monitoring 42 to reveal error cases of the position evaluation 46 with a high probability sufficient for the desired safety level in this manner. In the embodiment in accordance with FIG. 3, this is implemented in that the safe sensor 10 has different protected field configurations that mutually cover different zones in the detection zone 18 with protected fields 36, 38. There is in particular one protected field 36, 38 for every zone that omits this zone. Which protected field configuration has to be selected so that there is no protected field triggering at the found object positions is derived in the unsafe controller 40 from the results of the position evaluation 46.

If a person 34 moves through the detection zone 18, a protected field configuration is always dynamically selected with a proper routine of the position evaluation 46 so that no protected field 36, 38 is infringed. The protected fields 36, 38 moves back from the person 34 in this concept, so-to-say; the protected field status (OSSD) constantly remains “ON”. In an inverted logic, protected fields 36, 38 can conversely be selected that have been infringed in every current object position, that is that move along with the person 34, with the protected field status (OSSD) then remaining constantly “OFF”. As a further alternative, a moving back from protected fields 36, 38 through a muting zone moving along with the person 34 can be implemented. Protected fields 36, 38 are here bridged at the respective object position so that the protected field 36, 38 is not recognized as infringed despite the presence of the person 34.

As a result, an object position is thus recognized beside the protected field status that may be used for a subsequent safety related hazard evaluation thanks to the plausibilization. As part of object tracking, further values such as speed, prior or forecast object positions and the like can be acquired. If a hazard is recognized, a safety related signal is output to the monitored machine 32. The machine 32 thereupon becomes slower or diverges to worksteps that can at least not be a hazard with this recognized object movement and the machine is only switched to a safe state in case of an emergency. High availability and productivity are thus achieved overall. The results of the position evaluation 46 or object tracking, in particular the knowledge of the positions of all the persons present, that are of higher value in comparison with only protected field monitoring, can moreover be used in future safeguarding solutions that have an influence on the automatic processes at a higher level in a larger range up to an entire shop or factory.

FIG. 4 shows a representation of a safety architecture having a safe sensor 10, an unsafe controller 40, and in this embodiment now additionally a safety controller 48, with the latter initially generally to be understood as a safe evaluation of a processing unit on any desired hardware and only preferably as a safety controller in a narrower sensor. The matching protected field statuses are now determined in the unsafe controller 40, in addition to the position evaluation, and are transmitted to a plausibilization 50 in the safety controller 48. For this purpose, the geometries for the protected field monitoring 42 are also communicated to the unsafe controller 40, preferably during setting up.

The plausibilization 50 can thus compare the protected field statuses predicted by the unsafe controller based on the object position determined there with the actual protected field statuses of the protected field monitoring 42. It is not absolutely necessary for the confirmation of the correct function of the position evaluation 46 that there is complete agreement at all times since the protected field monitoring 42 determines the protected field status based on single pixel information while the position evaluation 46 works with model assumptions such as focuses and specified radii or bounding boxes. Tolerances should therefore actually be permitted for a margin of a protected field 36, 38 in the comparison of the plausibilization 50, in particular based on correlation measures in a temporal OSSD process. The results of the position evaluation 46 can only be used in a subsequent hazard evaluation in the case of a successful plausibilization.

FIG. 4 shows a yet further optional function of the unsafe controller 40 that can also be used in all the other embodiments, namely a data collection for the storing or providing of annotated training data. In this respect, the training data are the sensor data with which a result of the protected field monitoring 42 and/or position evaluation is/are automatically associated as an associated label. Such training data can then be used for the training of process of machine learning or an AI (artificial intelligence) model or a neural network. After a successful training, such a process is able to mimic the original function, also at a different location and in a different application, or is able to take over or supplement it in the safety application. The training data can respectively only be generated in response to a trigger so that they relevant and are not possibly erroneously annotated. A respective successful plausibilization 50 is in particular suitable for this purpose since it is thus clear that the sensor data have been correctly evaluated at this moment and have accordingly also bene correctly labeled. Additional conditions can be set, for instance that training data are only generated after a minimum change of the object position, at certain protected field statuses, or a total evaluation of the situation as hazardous or non-hazardous.

The relevant error scenarios can be reliably revealed and mastered by the described procedure and the plausibilization:
On a complete failure of the position evaluation 48, the expectation signal for protected field infringements, the muting signal, or the dynamic switchover of the protected fields 36, 38 are absent. Accordingly, no agreement is found in the plausibilization 50 or the protected field 36, 38 that has not been switched is infringed and this infringement is recognized in the protected field monitoring 12.
On a delayed performance or a freezing of the position evaluation 46, the expectation signal, muting signal, or dynamic switchover arrive with a delay or not at all, with the same consequence.
On a defective localization of the objects in the position evaluation 46, the expectation signal, muting signal, or dynamic switchover do not match the actual object position, again with the same consequence.
On a defective data transfer of the sensor data to the unsafe controller 40, the errors are either only minor and thus do not generate any relevant error function or the same consequence results as in the other error cases.
Additional measures such as checksums, time stamps, and packet IDs are preferably taken against a defective data transmission of the results of the unsafe controller 40 to a downstream unit, such as object positions, object lists, and the like. Alternatively, in an embodiment with a safety controller 48, plausibilization elements for the data transmission can be transmitted via the independent plausibilization channel of the safety controller 48. Particularly when a safe fieldbus is used here, redundant information or additional validation elements can be included in the transmission.

On a presence pf a plurality of persons 34 in the detection zone 18, there is no possibility in some situations for all the persons 34 to configure free zones without completely deactivating the protected fields 36, 38. This state would, however, be problematic from a technical safety aspect and will therefore preferably not be permitted at all. The problems can be defused to a certain degree by simultaneously monitored protected fields 36, 38, with there being limits if the number of persons in the detection zone 18 becomes too large. However, this only means that the machine 32 is not available as long as too many persons 34 dwell in its environment.

FIG. 5 shows a representation of a safety architecture having two safe sensors 10a-b and one unsafe controller 40 in a further embodiment of the invention. In the previous embodiments with only one safe sensor 10, common cause failures can occur that impact both system channels. Due to its safety suitability, the safe sensor 10 is admittedly robust with respect to such failures up to a certain degree, but the limitations of the individual components anyway also represent a limitation of the overall system. The safety level of the system function is thus in particular limited to the safety level of the individual safe sensor 10.

In an expansion of the concept with two safe sensors 10a-b, a plausibilization can take place by the respective other safe sensor 10b-a using its independent data basis, performing hardware, and perspective. The diversity of this approach makes safety related error cases extremely unlikely and so allows the deployment of higher safety levels for the overall solution.

In the embodiment in accordance with FIG. 5, the sensor data of the first sensor 10a are processed in a first position evaluation 46a and protected field switchovers for the second protected field monitoring 42b are thereby triggered in the second safe sensor 10b. Conversely, the sensor data of the second safe sensor 10b are processed in a second position evaluation 46b and protected field switchovers for the first protected field monitoring 42a are thereby triggered in the first safe sensor 10a. This embodiment manages without a safety controller.

FIG. 6 shows a representation of a safety architecture having two safe sensors 10a-b, one unsafe controller 40, and in this further embodiment having an additional safety controller 48 in contrast with FIG. 5. The results of the two position evaluations 46a-b are plausibilized crosswise in a first and second plausibilization 50a-b of the protected field monitoring processes 42b-a of the respective other safe sensor 10b-a. This system can utilize diversity for the safety observation to an again considerably greater extent.

1. A safety system for safeguarding a machine, wherein the safety system has at least one first safe sensor for the detection of sensor data from a detection zone in an environment of the machine and an unsafe evaluation unit; wherein the first safe sensor has a first safe evaluation unit for monitoring at least one protected field by a safe protected field evaluation of the sensor data, a first safe interface to output a result of the monitoring of the protected field, and a first unsafe interface to output sensor data to the unsafe evaluation unit; and wherein the unsafe evaluation unit is configured to determine object positions of objects in the detection zone by an unsafe position evaluation of the sensor data, wherein the safety system is furthermore configured to plausibilize the object positions based on the monitoring of the at least one protected field.

2. The safety system in accordance with claim 1,
wherein a plurality of protected fields are stored in the first evaluation unit that together form a pattern for possible object positions in the detection zone.

3. The safety system in accordance with claim 2,
wherein, depending on the object position in the pattern, a protected field omits this object position.

4. The safety system in accordance with claim 1,
wherein the unsafe evaluation unit is configured to continuously select a protected field based on a respective object position that is not infringed by an object at this object position.

5. The safety system in accordance with claim 1, wherein the unsafe evaluation unit is configured to continuously select a protected field based on a respective object position that is infringed by an object at this object position.

6. The safety system in accordance with claim 1, wherein the unsafe evaluation unit is configured to continuously select a muting zone based on a respective object position.

7. The safety system in accordance with claim 1,
that has a safety controller that compares the object position with a result of the monitoring of the at least one protected field.

8. The safety system in accordance with claim 7,
wherein the unsafe evaluation unit is configured to predict which protected field has been infringed based on the object position and to transmit this prediction to the safety controller.

9. The safety system in accordance with claim 1,
that has a second safe sensor for detecting sensor data from an environment of the machine that has a second safe evaluation unit for monitoring at least one protected field by a safe protected field evaluation of its sensor data; has a second safe interface to output a result of the monitoring of the at least one protected field; and has a second unsafe interface to output sensor data to the unsafe evaluation unit.

10. The safety system in accordance with claim 9,
wherein the safety system is configured to plausibilize the object positions from sensor data of the first sensor based on the monitoring of the at least one protected field of the second sensor and/or to plausibilize the object positions from sensor data of the second sensor based on the monitoring of the at least one protected field of the first sensor.

11. The safety system in accordance with claim 1,
wherein the unsafe evaluation unit is configured to carry out object tracking of objects in the detection zone

12. The safety system in accordance with claim 1,
wherein the first safe sensor is a 3D camera.

13. The safety system in accordance with claim 12, wherein the 3D camera is a time of flight camera.

14. The safety system in accordance with claim 1,
that is configured to store or output sensor data with an associated object position and/or a result of the protected field evaluation as annotated training data.

15. The safety system in accordance with claim 14, wherein the stored or output sensor data having the associated object position and/or the result of the protected field evaluation is respectively triggered by a successful plausibilization, a protected field infringement, and/or a terminated protected field infringement.

16. The safety system in accordance with claim 1,
that triggers a safety response of the machine when an object is at a hazardous position and/or in a hazardous motion.

17. The safety system in accordance with claim 1,
that is configured as a safe number of persons.

18. A method of safeguarding a machine in which sensor data from a detection zone are detected in an environment of the machine by at least one first safe sensor and are evaluated by a safe protected field evaluation for monitoring at least one protected field by the first sensor, sensor data are output to an unsafe evaluation unit and object positions are determined of objects located in the detection zone by an unsafe position evaluation there, and
wherein the object positions are plausibilized based on the monitoring of the at least one protected field.
